(19) United States
(12) Patent Application Publication
(10) Pub. No.: US 2012/0264897 A1
(43) Pub. Date: Oct. 18, 2012

(54) CATALYST SYSTEMS FOR RUBBER POLYMERIZATIONS

(76) Inventor: Thomas D. Ruehmer, Mansfeld-Grossener (DE)

(21) Appl. No.: 13/512,919

(22) PCT Filed: Dec. 1, 2010
(86) PCT No.: PCT/EP2010/007299

§ 371 Date: Jun. 22, 2012

Related U.S. Application Data
(60) Provisional application No. 61/265,887, filed on Dec. 2, 2009.

(51) Int. Cl. C08F 4/70; C08F 36/06

(52) U.S. Cl. 526/159; 502/117

(57) ABSTRACT

The invention provides a catalyst system comprising: A) cobalt II carboxylate, and B) at least one co-catalyst of the following Structure A wherein n is from 1 to 10, preferably from 1 to 6, and more preferably from 1 to 4; each R is independently an alkyl. The invention also provides a catalyst system comprising: A) cobalt II carboxylate; and B) the reaction product of at least the following components: i) trialkyl aluminum, ii) dialkyl aluminum chloride, iii) water, and wherein the molar ratio of aluminum to chloride (Al:Cl) is less than 1 (preferably 0.7 to 0.2), the molar ratio of water to aluminum (H₂O:Al) is from 0.5 to 0.92 (preferably from 0.55 to 0.75), and the molar ratio of trialkyl aluminum to dialkyl aluminum chloride from 0.5 to 5 (preferably from 1 to 5). The invention also provides a catalyst complex comprising the following: a) CoR′_{(2-χ)}Cl₍ₓ₎, wherein x is from 0.01 to 1, preferably from 0.1 to 1; and R′ is a carboxylate; b) (n−m)R2R3AlCl.mR1₃Al, wherein n is from 1 to 12, preferably from 1 to 6; m is from 1 to 10, preferably from 1 to 4; and n is greater than, or equal to, m; and R1, R2 and R3 are each independently an alkyl; and c) n/k H₂O, wherein k is from 1.5 to 11, preferably from 1.5 to 4.

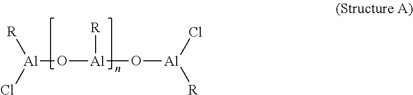

### REFERENCE TO RELATED APPLICATIONS

This application claims the benefit of the filing date under 35 U.S.C. §119(e) of Provisional U.S. Patent Application Ser. No. 61/265,887, filed Dec. 2, 2009, the entirety of which is hereby incorporated by reference.

### FIELD OF THE INVENTION

The present invention relates to an improved catalyst system for use in the polymerization of rubbers, and in particular, the polymerization of conjugated diolefins. More particularly the present invention relates to the selection of particular cobalt salts, together with particular alkylaluminum and alkylaluminum chloride compounds, and selected amounts of water, for use as a catalyst, particularly suited for the production of high-cis poly(butadiene) with low residual chloride.

### BACKGROUND OF THE INVENTION

The manufacture of high cis-1,4-polybutadiene (that is, greater than about 90 weight percent, more preferably greater than 95 weight percent in the cis formation) typically involve the polymerization of 1,3-butadiene, in an inert liquid polymerization medium, in the presence of a homogeneous catalyst system, with a chloride-containing co-catalyst. The catalyst system typically comprises a transition metal (for example, cobalt) salt with an alkyl aluminum chloride. However, chloride level in conventional “cobalt-synthesized, high-cis-butadiene rubber” has been identified as too high. Product improvement is needed, especially for impact polystyrene blends that need lower chloride levels in the blends, due to discoloration of high impact polystyrene (HIPS), and corrosion of production equipment. There is needed a modified catalyst system that results in lower chloride levels in the final polymer.

U.S. Pat. No. 6,887,956 discloses a catalyst system for use in the production of high cis polybutadiene. The catalyst system includes a cobalt salt of the formula CoAx, where A is a monovalent or divalent anion, and x is 1 or 2; an alkyl aluminum chloride compound of the structure R₂AlCl, and a catalytic amount of water. In R₂AlCl, the R group is an alkyl group containing 2-8 carbon atoms, and the molar ratio of “R:Al:Cl” is “2:1:1,” which for example can be achieved by mixing a trialkyl aluminum compound of the formula R₃Al and an alkylaluminum-sesquichloride of the formula R₃Al₂Cl₃), where R is an alkyl group containing 2-8 carbon atoms.

Japanese Publication No. 2003-313226 discloses a method for producing cis-1,4-polybutadiene, by polymerizing cis-1,3-butadiene using a catalyst substantially consisting of a transition metal compound, an organic aluminum compound, and a compound containing an active hydrogen atom in an inert solvent. For the organic aluminum compound, at least two compounds selected from the group consisting of an alkyl aluminum dihalide, a dialkyl aluminum halide, an alkyl aluminum sesquihalide and a trialkyl aluminum are used. The molar ratio of the total halogen to the total aluminum (total halogen/total aluminum) is more than 1.00, and less than 1.50.

U.S. Pat. No. 5,905,125 discloses a high cis-1,4-polybutadiene with reduced gel formation, and prepared using a catalyst from the following: (A) a cobalt compound, (B) a trialkyl (C1-10) aluminum compound, (C) a halide compound selected from those of formulae (1) and (2): (1) AIR²ₘX₃₋ₘ and (2) R³—X, wherein R²═C1-10 hydrocarbon, X=halogen, m=0 to 2, R³═C1-40 hydrocarbon, and (D) water in an amount of 0.77 to 1.45 moles per mole of total Al in components (B) and (C). The 1,3-butadiene is polymerized in the presence of the resultant catalyst in a polymerization medium including an alkane, cycloalkane and/or olefin hydrocarbon.

U.S. Pat. No. 5,397,851 discloses a process for producing high cis-1,4-polybutadienes, with reduced gel formation, comprising: polymerizing 1,3-butadiene in a polymerization medium comprising an inert hydrocarbon solvent and water, at a temperature from about −30° C. to about 60° C., in the presence of a catalyst system. The catalyst system is a mixture of (1) a substantially anhydrous divalent cobalt salt, (2) diethyl aluminum chloride or ethyl aluminum sesquichloride, and (3) an organo aluminum compound of the formula R₃Al, wherein R is an alkyl group having from 8 to 12 carbon atoms, and, optionally, triethylaluminum. The molar ratio of chloride in the diethyl aluminum chloride, plus (3), being from about 0.7:1 to about 1, and the molar ratio of chloride in the ethyl aluminum sesquichloride, plus (3), being from about 0.7:1 to about 1.4:1, and the ratio of the moles of the divalent cobalt salt to the total moles of diethyl aluminum chloride or ethyl aluminum sesquichloride, plus (3), being from about 1:15 to about 1:30. The water is employed at a level from about 0.1 to about 0.8 millimol for every millimol of diethyl aluminum chloride or ethyl aluminum sesquichloride used.

Japanese Publication No. 2004-083667 discloses a method for producing the high-cis polybutadiene, having a reduced aluminum metal content, and comprising the following: (A) forming the high-cis polybutadiene in an inert solvent, (B) terminating the polymerization, and adding an antioxidant to the obtained high-cis polybutadiene solution, (C) adding water to the high-cis polybutadiene obtained by the process (B), discharging ≧10 weight percent of the added water out of the system, and (D) stripping the high-cis polybutadiene obtained by the process (C), with steam, under an alkali condition, and separating the high-cis polybutadiene. Transition metal compounds containing cobalt or nickel may be used in the polymerization, along with organoaluminum compounds and water.

International Publication No. WO 2000/14130 discloses a process for the production of cis-1,4-polybutadiene having a low level of gel content. The process comprises polymerizing 1,3-butadiene in the presence of a catalyst and a polymerization diluent. The polymerization diluent comprises an organic solvent and water particles having a median particle size less than, or equal to, about 10 μm. It is disclosed that by controlling the mean particle size of the water present in the diluent, the level of gel content in the polymer product may be reduced. Anhydrous cobalt salts and organoaluminum halides are described as catalyst systems.

International Publication No. WO 2003/102041 discloses a process for the production of high cis-1,4-polybutadiene, which includes both very high and very low solution viscosity grades. The process comprises contacting a feed, comprising 1,3-butadiene, butene and cyclohexane, with a catalyst system, under conditions sufficient to polymerize the 1,3-butadiene; allowing the polymerization reaction to continue for a period of time sufficient, to produce the desired amount of the component with the relatively high molecular weight; and then adding an additional amount of catalyst, optionally, with a chain transfer agent, to the reaction mixture, under conditions sufficient to polymerize at least a portion of the remaining 1,3-butadiene. The invention also relates to materials made from the above process, especially materials having different levels of branching in the two components. Cobalt salts and organoaluminum compounds are described as catalyst systems. The system may also contain catalytic amounts of water.

Other references include U.S. Pat. No. 5,733,835, which discloses a catalyst system comprising an organo-cobalt compound, trialkyl aluminum and hexafluoro-2-propanol, and U.S. Pat. No. 3,336,280, which discloses a catalyst system comprising molybdenum pentachloride, organo-aluminum, and the use of amines as “promoters”. U.S. Pat. No. 3,135,725 teaches a high cis-polybutadiene produced by polymerizing 1,3-polybutadiene, in an inert solvent, in the presence of a catalyst, which contains cobalt in complex combination with an alkyl aluminum chloride. Additional references include the following: Nath et al., Polymerization of 1,3-Butadiene by Cobalt Dichloride Activated with Various Methylaluminumoxanes, Applied Catalysis A: General 238 (2003) 193-199; and Cass et al., Active Center Equilibrium in Ziegler-Natta Butadiene Polymerization, Journal of Polymer Science: Part A: Polymer Chemistry, Vol. 39, 2256-2261 (2001).

However, the state of the art requires high chloride levels (for example, molar ratio Al/Cl greater than one) to obtain sufficient catalyst activity, or settles for decreased catalyst activity (decreased conversion rates) at lower chloride levels. Also, “low chloride-containing rubber,” prepared using an anionic polymerization, typically does not produce a high cis-polybutadiene (for example, >90 weight percent of the butadiene units in the polymer are cis-1,4-butadiene units).

There is needed for a modified catalyst system that results in lower chloride levels in the final polymer, with maintained or improved catalysts activity (as indicated by monomer conversion rate). There is a further need for such systems that can be used to polymerize high cis-1,4-polybutadienes. These needs and others have been met by the following invention.

### SUMMARY OF THE INVENTION

The invention provides a catalyst system comprising:

A) cobalt II carboxylate, and

B) at least one co-catalyst of the following Structure A:

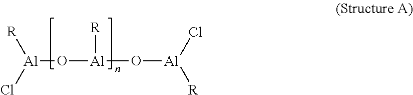

wherein n is from 1 to 10, preferably from 1 to 6, and more preferably from 1 to 4; each R is independently an alkyl.

The invention also provides a catalyst system comprising:

A) cobalt II carboxylate; and

B) the reaction product of at least the following components:
i) trialkyl aluminum,
ii) dialkyl aluminum chloride,
iii) water, and

wherein the molar ratio of aluminum to chloride (Al:Cl) is less than 1 (preferably 0.7 to 0.2), the molar ratio of water to aluminum (H₂O:Al) is from 0.5 to 0.92 (preferably from 0.55 to 0.75), and the molar ratio of trialkyl aluminum to dialkyl aluminum chloride from 0.5 to 5 (preferably from 1 to 5).

The invention also provides a catalyst complex comprising the following:

a) CoR′₍₂₋ₓ₎Cl₍ₓ₎, wherein x is from 0.01 to 1, preferably from 0.1 to 1; and R′ is a carboxylate;

b) (n−m)R2R3AlCl.mR1₃Al, wherein n is from 1 to 12, preferably from 1 to 6; m is from 1 to 10, preferably from 1 to 4; and n is greater than, or equal to, m; and R1, R2 and R3 are each independently an alkyl; and

c) n/k H₂O, wherein k is from 1.5 to 11, preferably from 1.5 to 4.

### BRIEF DESCRIPTION OF THE DRAWINGS

FIG. 1 depicts the conversion of 1,3-butadiene versus time for a batch polymerization (Batch 125).

FIG. 2 depicts the conversion of 1,3-butadiene versus time for a batch polymerization (Batch 126).

### DETAILED DESCRIPTION OF THE INVENTION

The invention provides a cobalt catalyst system can be used to polymerize rubbers, especially cis-polybutadiene, with low residual chloride levels. Lower chloride levels leads to easier catalyst removal; less discoloration in the final polymer product, and less corrosion in the manufacturing plants, especially in the HIPS production plant. It has also been discovered that this catalyst system provides a higher catalyst yield.

As discussed above, the invention provides a catalyst system comprising:

A) cobalt II carboxylate, and

B) at least one co-catalyst of the following Structure A:

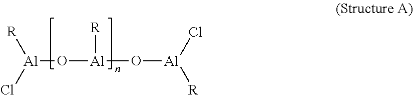

wherein n is from 1 to 10, preferably from 1 to 6, and more preferably from 1 to 4; each R is independently an alkyl. The identity of each R group is independent of the identities of the other R groups; and thus, each R group may or may not be the same alkyl as the other R groups.

In one embodiment, each R is independently a C1-C10 alkyl, a C2-C4 alkyl, or a C2-C8 alkyl.

In one embodiment, each R is independently a C1-C6 alkyl, a C2-C3 alkyl, or a C4-C8 alkyl.

In one embodiment, each R is independently a C1-C4 alkyl, a C2-C3 alkyl, or a C6-C8 alkyl.

In one embodiment, each R is independently a C1-C2 alkyl, a C2 alkyl, or a C6-C8 alkyl.

In one embodiment, each R is independently a methyl, an ethyl, or an n-octyl.

In one embodiment, the cobalt II carboxylate is present in an amount such that the molar ratio of Co to Al (Co:Al) is from 1:50 to 1:100, preferably from 1:50 to 1:70.

In one embodiment, the carboxylate of the cobalt II carboxylate is an octoate, an isooctoate, a naphthanate, a neodecanoate, or an acetylacetonate, and preferably a neodecanoate, an octoate, or an isooctoate, and more preferably a neodecanoate.

In one embodiment, the cobalt II carboxylate is cobalt neodecanoate.

The invention also provides a catalyst system comprising:

A) cobalt II carboxylate; and

B) the reaction product of at least the following components:
i) trialkyl aluminum,
ii) dialkyl aluminum chloride,
iii) water, and

wherein the molar ratio of aluminum to chloride (Al:Cl) is less than 1 (preferably 0.7 to 0.2), the molar ratio of water to aluminum (H₂O:Al) is from 0.5 to 0.92 (preferably from 0.55 to 0.75), and the molar ratio of trialkyl aluminum to dialkyl aluminum chloride from 0.5 to 5 (preferably from 1 to 5).

In one embodiment, the trialkyl aluminum is a tri(C1-C10 alkyl)aluminum, preferably a tri(C1-C8 alkyl)aluminum, more preferably a tri(C1-C4 alkyl)aluminum, and even more preferably a tri(C1-C2 alkyl)aluminum.

In one embodiment, the dialkyl aluminum chloride is a (C2-C4 alkyl)(C2-C8 alkyl) aluminum chloride, preferably a (C2-C3 alkyl)(C4-C8 alkyl) aluminum chloride, and more preferably a (C2-C3 alkyl)(C6-C8 alkyl) aluminum chloride.

In one embodiment, the trialkyl aluminum is a tri(C1-C10 alkyl)aluminum, preferably a tri(C1-C8 alkyl)aluminum, more preferably a tri(C1-C4 alkyl)aluminum, and even more preferably a tri(C1-C2 alkyl)aluminum; and the dialkyl aluminum chloride is a (C2-C4 alkyl)(C2-C8 alkyl) aluminum chloride, preferably a (C2-C3 alkyl)(C4-C8 alkyl) aluminum chloride, and more preferably a (C2-C3 alkyl)(C6-C8 alkyl) aluminum chloride.

In one embodiment, the cobalt II carboxylate is present in an amount such that the molar ratio of Co to Al (Co:Al) is from 1:50 to 1:100, preferably from 1:50 to 1:70.

In one embodiment, the carboxylate of the cobalt II carboxylate is an octoate, an isooctoate, a naphthanate, a neodecanoate, or an acetylacetonate, and preferably a neodecanoate, an octoate, or an isooctoate, and more preferably a neodecanoate.

In one embodiment, the cobalt II carboxylate is cobalt neodecanoate.

In one embodiment, the water to aluminum molar ratio is less than or equal to 0.75, preferably less than, or equal to, 0.67.

In one embodiment, the chloride to aluminum molar ratio is less than or equal to 0.70, preferably less than or equal to 0.60, more preferably less than or equal to 0.50.

In one embodiment, the water to dialkyl aluminum chloride molar ratio is greater than or equal to 1.0, preferably greater than or equal to 1.5, more preferably greater than or equal to 2.0.

In one embodiment, the water to dialkyl aluminum chloride molar ratio is from 1.0 to 5.5, preferably from 1.5 to 5.5, and more preferably from 2.0 to 5.5.

The invention also provides a catalyst complex comprising the following:

a) CoR′₍₂₋ₓ₎Cl₍ₓ₎, wherein x is from 0.01 to 1, preferably from 0.1 to 1; and R′ is an carboxylate, preferably a carboxylate selected from octoate, isooctoate, naphthanate, neodecanoate or acetylacetonate, more preferably a neodecanoate, an octoate, or an isooctoate, and even more preferably a neodecanoate.

b) (n−m)R2R3AlCl.mR1₃Al, wherein n is from 1 to 12, preferably from 1 to 6; m is from 1 to 10, preferably from 1 to 4; and n is greater than or equal to m; and R1, R2 and R3 are each independently an alkyl; and

c) n/k H₂O, wherein k is from 1.5 to 11, preferably from 1.5 to 4.

In one embodiment, R1 is a C1-C10 alkyl, R2 is a C2-C4 alkyl, and R3 is a C2-C8 alkyl.

In one embodiment, R1 is a C1-C8 alkyl, R2 is a C2-C3 alkyl, and R3 is a C4-C8 alkyl.

In one embodiment, R1 is a C1-C4 alkyl, R2 is a C2-C3 alkyl, and R3 is a C6-C8 alkyl.

In one embodiment, R1 is a C1-C2 alkyl, R2 is a C2-C3 alkyl, and R3 is a C6-C8 alkyl.

In one embodiment, R1 is methyl, and R2 is ethyl, and R3 is n-octyl.

In one embodiment, the R1₃Al is a tri(C1-C10 alkyl)aluminum, preferably a tri(C1-C8 alkyl)aluminum, more preferably a tri(C1-C4 alkyl)aluminum, and even more preferably a tri(C1-C2 alkyl)aluminum.

In one embodiment, the R2R3AlCl is a (C2-C4 alkyl)(C2-C8 alkyl) aluminum chloride, preferably a (C2-C3 alkyl)(C4-C8 alkyl) aluminum chloride, and more preferably a (C2-C3 alkyl)(C6-C8 alkyl) aluminum chloride.

In one embodiment, the R1₃Al is a tri(C1-C10 alkyl)aluminum, preferably a tri(C1-C8 alkyl)aluminum, more preferably a tri(C1-C4 alkyl)aluminum, and even more preferably a tri(C1-C2 alkyl)aluminum; and the R2R3AlCl is a (C2-C4 alkyl)(C2-C8 alkyl) aluminum chloride, preferably a (C2-C3 alkyl)(C4-C8 alkyl) aluminum chloride, and more preferably a (C2-C3 alkyl)(C6-C8 alkyl) aluminum chloride.

In one embodiment, the carboxylate of the cobalt II carboxylate is an octoate, an isooctoate, a naphthanate, a neodecanoate, or an acetylacetonate, and preferably a neodecanoate, an octoate, or an isooctoate, and more preferably a neodecanoate.

In one embodiment, the cobalt II carboxylate is cobalt neodecanoate.

In one embodiment, an inventive catalyst system further comprises a ternary alkyl amine, a ternary alkanol amine and/or a ternary aryl amine. In a further embodiment, the catalyst system comprises triethylamine. In another embodiment, the catalyst system comprises triethanolamine.

In one embodiment, the ternary alkyl amine, ternary alkanol amine, or ternary aryl amine is present in an amount such that the molar ratio of Co to N in the system is in the range of from 1:1 to 1:3.

An inventive catalyst system may comprise a combination of two or more embodiments as described herein.

The invention also provides a method of forming polybutadiene, comprising polymerizing 1,3-butadiene in the presence of an inventive catalyst system. In a further embodiment, the polybutadiene has a cis-1,4-polybutadiene content greater than 90 weight percent, more preferably greater than 95 weight percent, based on the weight of the polybutadiene.

In one embodiment, the polymerization is a solution polymerization. In a further embodiment, the polymerization is a batch polymerization.

The invention also provides a method of forming polybutadiene having a high cis content, comprising contacting a feed, comprising 1,3-butadiene, butene and cyclohexane, with an inventive catalyst system.

In one embodiment, the feed additionally comprises benzene.

In one embodiment, the feed comprises 20 percent, by weight, 1,3-butadiene and 55 percent, by weight, butene.

In one embodiment, the polymerization is a solution polymerization. In a further embodiment, the polymerization is a batch polymerization.

The invention also provides a method of reducing the amount of chloride in a polybutadiene, comprising polymerizing 1,3-butadiene in the presence of an inventive catalyst system. In a further embodiment, the polybutadiene has a cis-1,4-polybutadiene content greater than 90 weight percent, more preferably greater than 95 weight percent, based on the weight of the polybutadiene.

In one embodiment, the polymerization is a solution polymerization. In a further embodiment, the polymerization is a batch polymerization.

An inventive method may comprise a combination of two or more embodiments as described herein.

The invention also provides a polybutadiene formed in the presence of an inventive catalyst system. In a further embodiment, the polybutadiene has a cis-1,4-polybutadiene content greater than 90 weight percent, more preferably greater than 95 weight percent, based on the weight of the polybutadiene. In a further embodiment, the polybutadiene comprises less residual chloride than the polybutadiene of comparative example 5 (see Table 7 below).

The invention also provides a polybutadiene formed from an inventive method. In a further embodiment, the polybutadiene has a cis-1,4-polybutadiene content greater than 90 weight percent, more preferably greater than 95 weight percent, based on the weight of the polybutadiene. In another embodiment, the polybutadiene comprises less residual chloride than the polybutadiene of comparative example 5 (see Table 7 below).

An inventive polybutadiene may comprise a combination of two or more embodiments as described herein.

The invention also provides a high impact polystyrene (HIPS) comprising an inventive polybutadiene. In a further embodiment, the polybutadiene has a cis-1,4-polybutadiene content greater than 90 weight percent, more preferably greater than 95 weight percent, based on the weight of the polybutadiene. In another embodiment, the polybutadiene comprises less residual chloride than the polybutadiene of comparative example 5 (see Table 7 below).

An inventive high impact polystyrene (HIPS) may comprise a combination of two or more embodiments as described herein.

Cobalt salts include, but are not limited to, cobalt (II) acetylacetonate, cobalt (II) octoate, cobalt (II) isooctoate, cobalt (II) naphthanate, cobalt (II) neodecanoate and their cobalt (III) congeners. In general it is preferred that the cobalt salt be anhydrous. In a preferred embodiment, the cobalt salt is cobalt (II) neodecanoate.

Dialkyl aluminum chloride compounds include structures of formulas R₂AlCl and R2R3AlCl, where R₂ and R₃ are each independently an alkyl. In a preferred embodiment, the R2 and R₃ groups each independently contain 2-8 carbon atoms. The R2 or R3 group may be straight or branched. Suitable dialkyl aluminum chloride compounds include diethylaluminum chloride, di-n-butylaluminimum chloride, di-n-octylaluminum chloride, ethyl-n-octylaluminum chloride (EOAC). In one embodiment, an ethyl aluminum dichloride can be used.

Suitable trialkyl aluminum compounds include trimethyl aluminum, triethyl aluminum, and trioctyl aluminum. In a preferred embodiment, trimethyl aluminum is used.

The catalyst system also contains a catalytic amount of water. In a preferred embodiment, the amount of water should typically be in the range of 1 to 5.5 moles water per mole of the dialkyl aluminum chloride (for example, EOAC), and 1 to 5 mol trialkylaluminum (for example, trimethylaluminium) compound used, with about 1.5 to 5.5 mole water being most preferred. The exclusion of additional moisture can be achieved by maintaining a nitrogen, or other inert atmosphere, over the liquid when preparing the reaction mixture, and carrying out the polymerization.

As discussed above, the catalyst system may optionally contain a ternary alkyl amine, a ternary alkanol amine and/or a ternary aryl amine. The alkyl groups may be linear or branched. The alkanol groups may be linear or branched. Aryl groups can similarly be chosen from all existing materials. It is generally preferred, that the amine be somewhat water soluble, however, as this allows it to be more easily removed in water washes. Thus shorter carbon chain lengths, such as C6 or less, are generally preferred. It should be understood that the same amine may have alkyl and aryl characteristics. Suitable examples include triethylamine, tributylamine, triethanolamine, dimethylphenylamine, and triethanolamine, with triethylamine and triethanolamine being generally more preferred.

Solvents include aliphatic, cycloaliphatic, aromatic, and monoolefinic hydrocarbons, and mixtures thereof. Particularly well suited solvents include C4-C8 aliphatic hydrocarbons, C5 to C10 cyclic aliphatic hydrocarbons, C6 to C9 aromatic hydrocarbons, and C4 to C 6 monoolefinic hydrocarbons or mixtures thereof. Suitable solvents also include 2-butene, 1-butene, cyclohexane, benzene, pentane, hexane, heptane, toluene, and xylene. The solvent can also be useful to control the polymerization temperature by refluxing. In this regard, it should be appreciated that by mixing two or more solvents, the desired polymerization temperature can be more precisely achieved.

Normally the polymerization is conducted at a temperature in the range from −35° C. to 100° C., more preferably from −10° C. to 50° C., most preferably from 0° C. to 40° C. The polymerization can be conducted in a pressure autoclave if desired. In one embodiment, the polymerization is carried out in the following manner: the butadiene feed, and co-catalyst (structure A), are added to the reaction vessel in any order, and are mixed together, in the reaction vessel, or before addition to the reaction vessel. The cobalt catalyst can then be added, optionally pre-dissolved in a suitable solvent or solvent mixture, and the polymerization carried out.

### DEFINITIONS

The term “polybutadiene,” as used herein, refers to a homopolymer of butadiene.

The term “composition,” as used herein, includes a mixture of materials, which comprise the composition, as well as reaction products and decomposition products formed from the materials of the composition.

The term “polymer,” as used herein, refers to a polymeric compound prepared by polymerizing monomers, whether of the same or a different type. The generic term polymer thus embraces the term homopolymer (employed to refer to polymers prepared from only one type of monomer), and the term interpolymer as defined hereinafter.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The following examples are presented to further illustrate the invention; however they are not intended to limit the scope of the invention to these particular embodiments.

### EXPERIMENTAL

The following polymerization reactions were carried out in a four liter stainless steel stirred reactor, equipped with a cooling circuit and a premixing vessel, and the necessary auxiliaries, like inlets and outlets for nitrogen, solvents, and catalysts. In each case, the reactor was charged with three liters of a dry feed consisting of 20 percent, by weight, 1,3-butadiene, 55 percent, by weight, butenes (ratio of butene-2/butene-1 was about 0.3), and 25 percent, by weight, cyclohexane/benzene (ratio of cyclohexane to benzene was about 0.65). Each weight percent is based on total weight of feed. At 25° C., a previously prepared mixture, containing the aluminum alkyl compounds (reagents for cocatalyst in cyclohexane) and water, was added to the premixing vessel, so as to obtain a 0.04 molar solution of Al, which corresponded to 0.0024 molar solution in the reactor. The water to aluminum ratio was approximately 0.63. The polymerization was then initiated by injection of a cobalt solution (0.2% by weight cobalt in cyclohexane/benzene-mix) into the reactor, so as to obtain a cobalt concentration of 1.9 ppm (based on total weight of total feed). All materials were handled in a dry nitrogen atmosphere. The solvents and 1,3-butadiene were passed over alumina columns, and then added to the reactor. The following monomer solution (see Table 1), with the cobalt in form of cobalt (II)-neodecanoate, was used for each batch polymerization.

TABLE 1
Compositions of Polymerization Feeds

| Feed A | |
|---|---|
| 1,3-Butadiene (wt %)* | 20 |
| Butene-2/butene-1 (0.3/1 weight ratio) (wt %)* | 55 |
| Cyclohexane/benzene (40/60 weight ratio) (wt %)* | 25 |
| Cobalt (ppm)* | 1.9 |
| Feed B | |
| Cyclohexane/benzene (40/60 weight ratio) (wt %) | 6 |
| CH₃Al (ppm) | 58 |
| (CH3CH2)(CH3—(CH2)7)AlCl (ppm) | 495 |
| Water (ppm) | 36 |

*Each wt % or ppm based on total weight of Feed A plus Feed B.

The following reagents were used for the first co-catalyst solution prepared in the premixing vessel (Premix 125 into Batch 125):

a) 8.2 ml trimethyl aluminum (TMA, 2 wt % in cyclohexane),

b) 10.0275 ml ethyl octyl aluminum chloride (EOAC, 13.9 wt % in cyclohexane),

c) 120 ml Benzene containing 620 ppm H₂O. The “ppm amount” water is based on weight of benzene and water.

Preparation of cocatalyst—insitu with the basic Structure A-complex n=whole numbers: 1, 2, 3, . . . , 5 and k=a+b</=3n and a,b</=2
n(CH₃)₃Al+2(CH₃—CH₂)(CH₃—(CH₂)₇)AlCl(EOAC)+(n+1)H₂O---->(3n−k)CH₄+aC₂H₆+bC8H₁₈+[structure-A-complex]

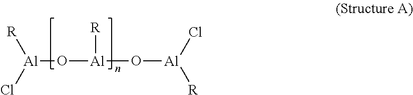

For each possible Structure (A), the R groups are exchangeable, and correspond to the alkyl groups as introduced by the (R₁)₃Al and the R₂R₃AlCl. The ratio of “R₁═CH₃:R₂═CH₃—CH₂:R₃═CH₃—(CH₂)₇:Al:Cl” is “1:1:n:(1+n):1,”

The above components (a, b, c) were added to the premixing vessel of the reactor, in the order a), b), c), and the resultant mixture was stirred for two minutes, at room temperature, to form the co-catalyst solution. Next, the co-catalyst solution (83.5 ml) was added to the four liter polymerization reactor, containing the monomer solution (2.4 l), as shown in Table 1 (Feed A). Next, cyclohexane, containing the cobalt compound (4 ml, 1.9 ppm cobalt based on the total weight of Feeds A+B), was added to initiate the polymerization at room temperature.

For the second polymerization (Premix 126 into Batch 126), the following reagents were used:

a) 9.65 ml TMA (2 wt % in cyclohexane),

b) 11.8 ml EOAC (13.9 wt % in cyclohexane), and

c) 120 ml Benzene containing 620 ppm H₂O.

The above components were added to the premixing vessel of the reactor in the order a), b), c), and the resultant mixture was stirred for two minutes, at room temperature, to form the co-catalyst solution. Next, the co-catalyst solution (69 ml) was added to the four liter polymerization reactor, containing the monomer solution (2.4 l) as shown in Table 1. Next, cyclohexane, containing the cobalt compound (4 ml, 1.9 ppm cobalt (based on the total weight of Feeds A+B)), was added to initiate the polymerization at room temperature.

For each polymerization (Batch 125 and Batch 126), the water in each feed to the reactor was adjusted to provide the given water/aluminum trialkyl ratio and water/aluminum alkylchloride ratio as shown in Table 2.

TABLE 2
Molar Ratios of reagents

| | Example | Comparative |
|---|---|---|
| In Premixing Vessel | 1 & 2 | Example |
| nAl(EOAC)/nAl(TMA)/ | 3 | only EOAC |
| nAl(EOAC)/nH₂O | 1.64 | 2 |
| nAl/nCl | >1.3 | 1 |
| In Reactor | | |
| Chloride | 0.0025 | 0.00332 |
| Molar ratio Cobalt/Al* | 100 | 133 |

*Al = total moles of Al from TMA and EOAC

The conversion of the 1,3-butadiene to polybutadiene was monitored by GC (Gas Chromatography) analysis. At approximately 75 percent conversion of the 1,3-butadiene (based on total weight of 1,3-butadiene charged to reactor), the polymerization was terminated by the addition of ethanol (2 ml) to the reactor. The polymer solution was then washed with water, and coagulated after the addition of a standard hindered phenol antioxidant polymer stabilizer. The conversion times are reported in Tables 3 and 5 (see also Table 7 for a comparative example).

Gas Chromatography

As part of the polymerization tests for <<Cobalt-Butadiene Rubber (CoBR>> the butadiene conversion was measured via analysis of the gas phase in the reactor by gas chromatography (FID). HP-Agilent 6890 series.

The gaseous phase was analyzed, after completely charging the reactor, in order to determine the butadiene content at t=0. After injection of the catalyst, the decrease of butadiene (=polybutadiene conversion) was measured by successive sampling of the gaseous phase, in the following sequences of time (t=3 min, t=7 min . . . and then every 5 min) until 75% conversion was achieved.

Chromatography conditions were as follows.

### Column

| | |
|---|---|
| type | AT-Alumina (ALLTECH) |
| phase | Alumina |
| material | silica gel |
| length | 30 m |
| diameter | 0.53 mm (ID) |
| temperature | 150° C. |
| carrier gas | helium |
| feed | 7 ml/min |

### Injector

| | |
|---|---|
| type | injector with divider (split) |
| feed of leakage | 170 ml/min |
| temperature | 180° C. |
| injection volume | 30 μl |

### Detector

| | |
|---|---|
| type | flame ionization detector (FID) |
| temperature | 200° C. |
| hydrogen feed | 50 ml/min |
| air feed | 500 ml/min |

Sampling

Each sample was taken by a gas tight syringe through a valve on top of the reactor. The results are estimated in weight-% (following the conversion by GC by measuring decrease in butadiene (mainly C4-containing solvent mix)).

Monomer (Butadiene):

Conversion=(1−(ConcBD(at tₓ)/(SUM(concentration of the butenes))/(ConzBD(t₀)/(Sum(concentration))))*100%

By determination of the peak areas

m=(% conv/100%)*mBDo

[BDo]=20 wt %

The recovered product was then subjected to the following analytical tests. Molecular weight determinations (both Mw and Mn) were carried out with Gel Permeation Chromatography using a Waters GPC system, maintained at an internal temperature of about 30° C.

GPC Reagents and Samples
Tetrahydrofuran (THF): Merck, HPLC-grade (inhibited with di-tert-butyl-2,6-methyl-4-phenol, 50 mg/kg)
Narrow molecular weight distributed polystyrene standard: Polycal TDS-PS PS90K from Viscotec
Narrow molecular weight distributed polystyrene standards from Pressure Chemicals, USA, with the following characteristics:

| Lot Number | Mw in g/mol | Mw/Mn |
|---|---|---|
| 30525 | 4,000 | ≦1.06 |
| 80317 | 30,000 | ≦1.06 |
| 50912 | 200,000 | ≦1.06 |
| 00507 | 400,000 | ≦1.06 |
| 80323 | 900,000 | ≦1.10 |
| 61111 | 2,000,000 | ≦1.30 |

Refractive index: offset=0.000; calibration factor=6.7314e+007

Low Angle Light Scattering: offset=−0.3748; calibration factor=6.8362e−008

Viscometer: offset=−0.1322; calibration factor=1.2121

GPC Analysis Conditions

Instrument: Waters 515 HPLC pump, WISP 717+injector, CHR oven

Columns: Three in series: Plgel 10 μm Mixed-B LS

30-cm×7.5-mm i.d.

Column temperature: 30° C.

Eluent: HPLC-grade tetrahydrofuran (THF)

Flow: 0.8 mL/minute

Injection volume: 100 μL

Pre-Column In-line Filter: Waters 0.5-1 μm stainless frit

Refractive Index detector settings (temperature 30° C.)

Polarity positive

Sensitivity 256

Sampling rate 2

Viscosity detector settings IP conversion factor 1 kPa/mV

DP conversion factor 1 Pa/mV

flow rate through viscometer: 0.5 mL/min

Right angle Light Scattering detector Laser wavelength: 670 nm

Low angle light scattering detector Laser wavelength: 670 nm

Refractive index solvent 1.405

Refractive index increment do/dc: 0.133 mL/g (polybutadiene) for measurements and 0.185 mL/g (polystyrene) for calibration step

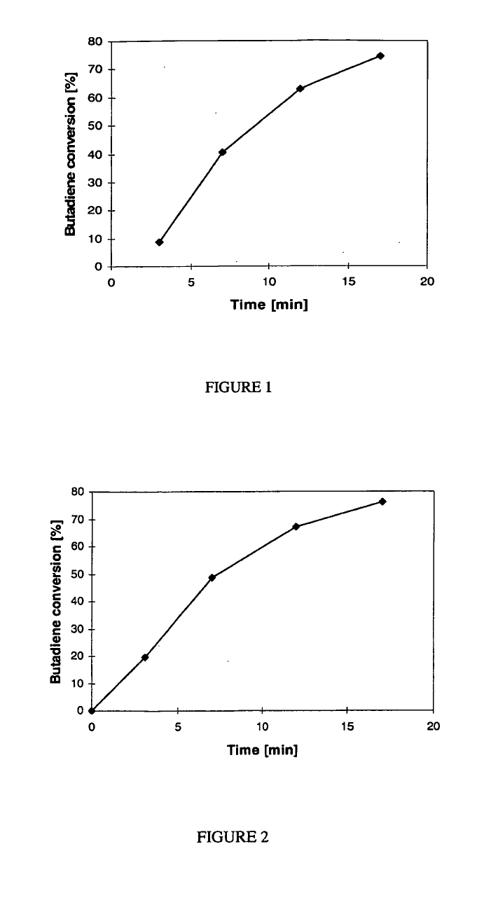

The butadiene conversion for the first batch polymerization (Batch 125) is shown in Table 3 and FIG. 1.

TABLE 3
Butadiene Conversion - Batch 125

| Time | Butadiene | Mw | Mn | D |
|---|---|---|---|---|
| (min) | Conversion in % | [10⁻³ g/mol] | [10⁻³ g/mol] | [Mw/Mn] |
| 0 | 0 | 0 | 0 | 0 |
| 3 | 8.91 | 328 | 175 | 1.9 |
| 7 | 40.6 | 316 | 141 | 2.2 |
| 12 | 62.98 | 308 | 120 | 2.6 |
| 17 | 74.56 | 313 | 111 | 2.8 |

The final polymer polymerization solution/polymer is described in Table 4. Viscosities of products at five percent, by weight, in styrene solvent (VS) were determined by conventional viscometric techniques, according to ASTM D0446. Mooney viscosities (VM) were determined according to ASTM 1646, ML 1+4 at 100° C., with a preheating time of one minute, and a rotor operation time of four minutes, at a temperature of 100° C. [ML1+4(100° C.)], on a MV2000 E from Alpha-Technologies.

To determine “1,4-cis”, “1,4-trans” and “1,2-vinyl” levels, the samples were dissolved in CDCl₃/TMS, and examined by NMR spectroscopy (¹H NMR and ¹³C NMR according to ASTM D3677). NMR spectrometer BRUKER AVANCE 200; 5 mm Dual probe; ¹H and ¹³C NMR spectroscopy; Solvent: CDCl₃/TMS.

TABLE 4
Polymer Properties of Final Polymerization Solution/Polymer -
Batch 125

| | |
|---|---|
| Mooney (ASTM D1646) | 56 |
| wt % solids (based on total feed) | ~15 |
| Mn (finished product) | 102 |
| Mw (finished product) | 276 |
| Polydispersity | 2.7 |
| 1,4-cis/1,4-trans/1,2-vinyl | 96.2/1.8/1.5 |
| Stabilizer IRGANOX 1076 | 0.57 |

The butadiene conversion for the second batch polymerization (Batch 126) is shown in Table 5 and FIG. 2. The final polymer polymerization solution/polymer is described in Table 6.

TABLE 5
Butadiene Conversion - Batch 126

| Time | Butadiene | Mw | Mn | D |
|---|---|---|---|---|
| (min) | Conversion in % | [10⁻³ g/mol] | [10⁻³ g/mol] | [Mw/Mn] |
| 0 | 0 | 0 | 0 | 0 |
| 3 | 19.69 | 210 | 106 | 2.0 |
| 7 | 48.61 | 207 | 84 | 2.5 |
| 12 | 67.05 | 215 | 83 | 2.6 |
| 17 | 76.24 | 221 | 86 | 2.6 |

TABLE 6
Polymer Properties of Final Polymerization Solution/Polymer -
Batch 126

| | |
|---|---|
| Mooney (ASTM D1646) | 34 |
| % solids | ~15 |
| Mn (finished product) | 75 |
| Mw (finished product) | 230 |
| Polydispersity | 3.1 |
| 1,4-cis/1,4-trans/1,2-vinyl | 95.2/2.4/2 |
| Stabilizer Irganox 1076 | 0.49 |

The conversion rate of a polymer (polybutadiene) produced using a comparative catalyst system is shown in Table 7.

TABLE 7
Comparative example (see U.S. Pat. No. 6,887,956)

| | | | | Conversion |
|---|---|---|---|---|
| | | | Conversion 25% | 75% |
| Example | R2AlCl | Cobalt Salt | (min) | (min) |
| 5 | EOAC | Cobalt | 7.5 | 37 |
| | | neodecanoate | | |

As shown in Tables 3, 5 and 7 above, the inventive catalyst systems (catalyst plus cocatalyst) provide higher conversion rates compared to the comparative catalyst system (see Table 7). In addition, the inventive catalyst systems polymerized polymer with less catalyst, less cocatalyst, and about 50 wt % less chloride (compared to the comparative example 5), for same amount polymer produced. Also, lower levels of chloride would be present in polymer formed from an inventive catalyst system, as compared to polymer prepared from the comparative catalyst system.

In a rubber manufacturing plant, chloride content in the rubber product is typically reduced by extraction processes, for example, washing, coagulation, and stripping. For rubbers prepared with an inventive catalyst system, as discussed herein, less chloride (for example, 50 wt % less chloride) is present in the polymerized rubber, and thus, less chloride has to be extracted from this rubber. In addition, lower levels of residual chloride would be present in the finished rubber.

It should be realized by those skilled in the art that the invention is not limited to the exact configuration or methods illustrated above, but that various changes and modifications may be made without departing from the spirit and scope of the invention, as described by the following claims:

1-19. (canceled)

20. A catalyst system comprising:
A) cobalt II carboxylate, and
B) at least one co-catalyst of the following Structure A: 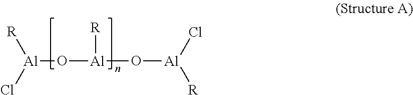
wherein n is from 1 to 10, preferably from 1 to 6, and more preferably from 1 to 4; each R is independently an alkyl; and wherein the cobalt II carboxylate is present in an amount such that the molar ratio of Co to Al (Co:Al) is from 1:50 to 1:100.

21. The catalyst system of claim 20, wherein at least one R is independently a C1-C10 alkyl; at least another R is independently a C2-C4 alkyl; and at least another R is independently a C2-C8 alkyl.

22. The catalyst system of claim 20, wherein at least one R is independently a C1-C8 alkyl; at least another R is independently a C2-C3 alkyl; and at least another R is independently a C4-C8 alkyl.

23. The catalyst system of claim 20, wherein at least one R is independently a C1-C2 alkyl; at least another R is independently a C2-C3 alkyl; and at least another R is independently a C6-C8 alkyl.

24. The catalyst system of claim 20, wherein the cobalt II carboxylate is cobalt neodecanoate.

25. A method of forming polybutadiene, comprising polymerizing 1,3-butadiene in the presence of the catalyst system of claim 20.

26. The method of claim 25, wherein the polybutadiene has a cis-1,4-polybutadiene content greater than 90 weight percent based on the weight of the polybutadiene.

27. A method of forming high impact polystyrene (HIPS), comprising polymerizing 1,3-butadiene in the presence of the catalyst system of claim 20 to form a polybutadiene.

28. A catalyst system comprising:
A) cobalt II carboxylate; and
B) the reaction product of at least the following components:
i) trialkyl aluminum,
ii) dialkyl aluminum chloride,
iii) water, and
wherein the molar ratio of chloride to aluminum (Al:Cl) is less than 1; the molar ratio of water to aluminum (H₂O:Al) is from 0.5 to 0.92; the molar ratio of trialkyl aluminum to dialkyl aluminum chloride is from 0.5 to 5; and wherein the cobalt II carboxylate is present in an amount, such that the molar ratio of Co to Al (Co:Al) is from 1:50 to 1:100.

29. The catalyst system of claim 28, wherein the cobalt II carboxylate is cobalt neodecanoate.

30. The catalyst system of claim 28, wherein the water to aluminum molar ratio is less than, or equal to, 0.75.

31. The catalyst system of claim 28, wherein the chloride to aluminum molar ratio is less than, or equal to, 0.70.

32. The catalyst system of claim 28, wherein the water to dialkyl aluminum chloride molar ratio is greater than, or equal to, 1.0.

33. The catalyst system of claim 28, wherein the water to dialkyl aluminum chloride molar ratio is from 1.0 to 5.5.

34. A method of forming polybutadiene, comprising polymerizing 1,3-butadiene in the presence of the catalyst system of claim 28.

35. The method of claim 34, wherein the polybutadiene has a cis-1,4-polybutadiene content greater than 90 weight percent based on the weight of the polybutadiene.

36. A method of forming high impact polystyrene (HIPS), comprising polymerizing 1,3-butadiene in the presence of the catalyst system of claim 28 to form a polybutadiene.

37. A catalyst system comprising the following:
a) CoR′₍₂₋ₓ₎Cl₍ₓ₎, wherein x is from 0.01 to 1; and R′ is a carboxylate;
b) (n−m)R²R³AlCl.mRI₃Al, wherein n is from 1 to 12; m is from 1 to 10; n is greater than, or equal to, m; and R1, R2 and R3 are each independently an alkyl; and
c) n/k H₂O, wherein k is from 1.5 to 11.

38. The catalyst system of claim 37, wherein the cobalt II carboxylate is cobalt neodecanoate.

39. A method of forming polybutadiene, comprising polymerizing 1,3-butadiene in the presence of the catalyst system of claim 37.

40. The method of claim 39, wherein the polybutadiene has a cis-1,4-polybutadiene content greater than 90 weight percent based on the weight of the polybutadiene.

41. A method of forming high impact polystyrene (HIPS), comprising polymerizing 1,3-butadiene in the presence of the catalyst system of claim 37 to form a polybutadiene.
